(19) United States
(12) Patent Application Publication
(10) Pub. No.: US 2003/0159698 A1
(43) Pub. Date: Aug. 28, 2003

(54) Therapeutic support pad

(76) Inventor: Dexter Lee Porterfield, Valdosta, GA (US)

Correspondence Address: Brian D. Bellamy, P.O. Box 1997, Thomasville, GA, 31799-1997, US

(21) Appl. No.: 10/083,979

(22) Filed: Feb. 27, 2002

(51) Int. Cl. A61G 15/00

(52) U.S. Cl. 128/845

(57) ABSTRACT

A therapeutic support pad comprising a pliable and elastic elongate core comprised of a gel filling, a flexible wall member enveloping the core to form a bladder, and an elongate tubular member of polymeric foam covering the wall member. The combination of the tubular member and core is cylindrically shaped and between 24 and 36 inches in length and 2 to 4 inches thick. A covering may be provided for comfort and appeal, and the covering may include an elastic strap for retaining the pad in a folded configuration. The tubular member is less pliable than the core, but still capable of being folded. The pad may be used in an elongate configuration for placement in alignment with the spine for stretching invertebrate discs and the muscular skeletal tissue of the spine for relief of tension or compression thereof.

### BACKGROUND OF THE INVENTION

1. Field of the Invention

This invention relates to anatomical supports and therapeutic devices for treatment of the invertebrate discs, viscoelastic and muscular skeletal tissue of the entire spine. More particularly, the invention is directed to a flexible elongate pad for support and therapeutic treatment of the cervical, thoracic, lumbar, and sacro-pelvic region of humans.

2. Description of Prior Art

Many people face the pervasive problems of neck and back discomfort caused by injury or improperly designed seating or bedding. Such discomfort may be from lack of proper support or from pain in the neck or back that can be alleviated through therapeutic manipulation or relaxation. Some persons suffer from spinal misalignment and/or muscular skeletal tension or compression that may be at least partially corrected or relieved by a person lying supine on the floor and positioning a makeshift device such as elongate rolled towel beneath their spine. Such relief is provided by stretching the invertebrate muscles to alleviate compression of the invertebrate disc tissue through enhancement of the natural curvature of the spine. Eventually, the discomfort may improve by such manipulation and stretching. However, many persons frequently turn to treatment by chiropractors or pain medication even for relatively minor nagging aches that could be effectively treated at home if a proper support or therapeutic device were available.

The prior art does not provide a means whereby a person can conveniently support various portions of his or her body with an easily adjustable elongate pad of proper construction that promotes even distribution of weight for support or therapeutic treatment. Although a wide variety of devices for support or therapeutic treatment of the spinal regions of the body have become available over the years, most all have been designated for a particular region of the body such as the neck, the lower back, or the spine. Therefore, prior art devices are designed to only support or manipulate specific tissue or bones of a specific region of the spine. Further, the known devices and pads illustrated by several representative patents mentioned hereinafter are subject to one or more short-comings with respect to their ability to stretch various spinal muscles and viscoelastic tissue of the spine, and many known devices are somewhat difficult to use, costly to manufacture, or uncomfortable for the user.

In consideration thereof, some prior art teaches devices having portions of varying rigidity. The rigid components of such prior art devices limit the functionality of the device to a particular need and increase the cost of manufacturing the device. For example, U.S. Pat. No. 2,854,971 to Williams teaches a spinal treatment device that is stiffer in the middle section than at the ends, and U.S. Pat. No. 5,675,850 to Schmitt teaches a lumber treatment device that is firmer on the ends than in the middle portion. Devices that include rigid members in combination with flexible and softer portions do not offer the advantages provided by the uniform distribution of pressure across a portion of the body and have decreased flexibility and function because of the rigid members used in the construction of the devices.

Some support pads taught by the prior art provide a very pliable gel filling. U.S. Pat. No. 3,858,379 to Grave and Ritchey teaches a gel filled support pad for preventing decubitus ulcers. U.S. Pat. No. 4,672,700 to Poncy also presents a gel filled cushion for preventing decubitus ulcers. While these types of pads or cushions provide for even distribution of body weight on the pad, they do not provide sufficient firmness to manipulate tissue or bones and provide additional function beyond antidecubitis treatment. Further, these gel filled pads are generally flat and rectangular and not suitable for spinal manipulation or supporting a variety of regions of the spine including the lumber or cervical.

Thus, despite the many support pads and therapeutic devices available for the back and neck and treatment of the spine, a need still exists for a single device capable of being used a variety of ways for support of the back or neck, relief of compression of invertebrate discs in the spine, or even placement behind a person's neck, lumbar, or spinal column while driving a car. A well-designed simple support and therapeutic device for these needs should also be easy to use, convenient to store, and inexpensive to construct.

### SUMMARY OF THE INVENTION

My invention provides a cylindrical elongate pad that is approximately the length of spinal region of a person's back. The pad may be placed beneath the spine to apply evenly distributed pressure for manipulation and relief of muscular tension and tissue compression in the various regions of the spine. Also, the pad is flexible and may be folded to conform to various configurations of the pad for a variety of uses as a support or therapeutic device. The pad includes a gel-filled core that is soft and pliable and promotes even distribution of pressure, and the pad includes a less pliant foam tubular member about the core that is firm and promotes proper support and manipulation of tissue and vertebrae. One or more straps may be included on a covering about the device that are useful in retaining the pad in a folded configuration for supporting the thoracic, lower lumber, the cervical, sacro pelvic, or other portions of the spine or body.

Thus, an object of the invention is to provide a pad having sufficient flexibility and firmness for configuration and application to several different regions of the spine or body.

Another object of the invention is to provide a pad for therapeutic manipulation of variety of body tissue and spinal vertebrae to relieve discomfort or pain in the neck or back areas of the body.

Another object of the invention is to provide an elongate pad to assist in therapeutic treatment in relieving compression of the invertebrate discs in the spine and surrounding muscles.

And yet, another object of the invention is to provide an elongate pad that is simple and inexpensive to manufacture to replace makeshift objects such towels being used for support and therapy with respect to the body, particularly the spine.

### BRIEF DESCRIPTION OF THE DRAWINGS

FIG. 1 is a side plan view of a human spine.

FIG. 2 is a side plan view of the thoracic region of the human spine with invertebrate tissue shown compressed.

FIG. 2b is a side plan view of the thoracic region of the human spine shown in a corrected condition without compression of the invertebrate tissue.

FIG. 3a is a side plan view of the sacro pelvic region of the human spine with the invertebrate tissue shown in tension.

FIG. 3b is a side plan view of the sacro pelvic region of the human spine shown in a corrected condition without tension in the invertebrate tissue.

FIG. 4 is a plan view of the pad of the invention shown on a person's back aligned longitudinally with the person's spine.

FIG. 5a is an end plan view of the position of the pad when optionally positioned longitudinally along a persons spine.

FIG. 5b is a side plan view of the pad when used for therapeutic manipulation of the spine while a person lies supine with his or her spine supported by the pad.

FIG. 6 is an end plan view of the pad when used for therapeutic manipulation of the spine while a person lies supine with his or her sacro pelvic region of the spine supported by the pad.

FIG. 7 is an end plan view of the pad when optionally folded and positioned transversely beneath a supine person's neck.

FIG. 8 is an end plan view of the position of the pad when optionally positioned transversely beneath a person's neck.

FIG. 9a is a side plan view of the position of the pad when optionally placed in longitudinal alignment with a person's spine while sitting upright in an automobile seat.

FIG. 9b is a side plan view of a person sitting in an automobile seat with the folded pad of this invention placed transversely across the lower back for added support of the lumbar region of the spine.

FIG. 10a is a side plan view of the position of the pad when optionally placed about the neck rest of an automobile seat for added support of the cervical region of the spine while a person is sitting upright in the automobile seat.

FIG. 10b shows in more detail the pad placed about an automobile neck rest as in FIG. 10a.

FIG. 11a is a bottom plan view of the pad including a retaining strap and a closure device on the external covering.

FIG. 11b is a top plan view of the pad having an external covering and retaining strap.

FIG. 11c is a bottom plan view of the pad showing a closure device opened for insertion of a main pad member.

FIG. 12a is a plan view of the pad while held in a folded configuration using the retaining strap.

FIG. 12b is a plan view of the pad in a folded configuration as in FIG. 12a in which the retaining strap has a velcro attachment member.

FIG. 13 is an end cross-sectional view of the pad illustrating components thereof.

FIG. 14 is a bottom plan view of the pad with portions cut-away to illustrate components thereof.

### DETAILED DESCRIPTION OF THE INVENTION

Referring now to the figures, a preferred embodiment of the invention is shown in the form of an elongate therapeutic support pad 20. When not placed under a load, the pad 20 is shaped cylindrically about its longitudinal axis to provide a long and thin elongate structure of excellent length for manipulation and folding into additional supportive shapes and a convenient length for storage or travel. The overall diameter of the pad 20 is preferably about two to four inches when not compressed by a load, and the fully elongate pad's preferred length will measure about the length of a person's spine 10 from the base of the neck to the pelvis. More particularly, a standard diameter of the pad of between 2.25 inches and 2.75 inches when not compressed has been found advantageous, such that the overall circumference of the pad 20 is about 7.75 inches. Measurements of adults indicate in many instances the length of an adult sized pad 20 should measure in a range of about twenty-four to thirty-six inches. A standard one size to fit all pad 20 could be designed to fall within this range. For instance, a length of twenty-four to twenty-eight inches will suit most average height adults. Nonetheless, the length may be varied to accommodate people of different heights with different length spines. Also, the length of the pad 20 may be adjusted by folding it to provide a pad 20 that is shorter and wider.

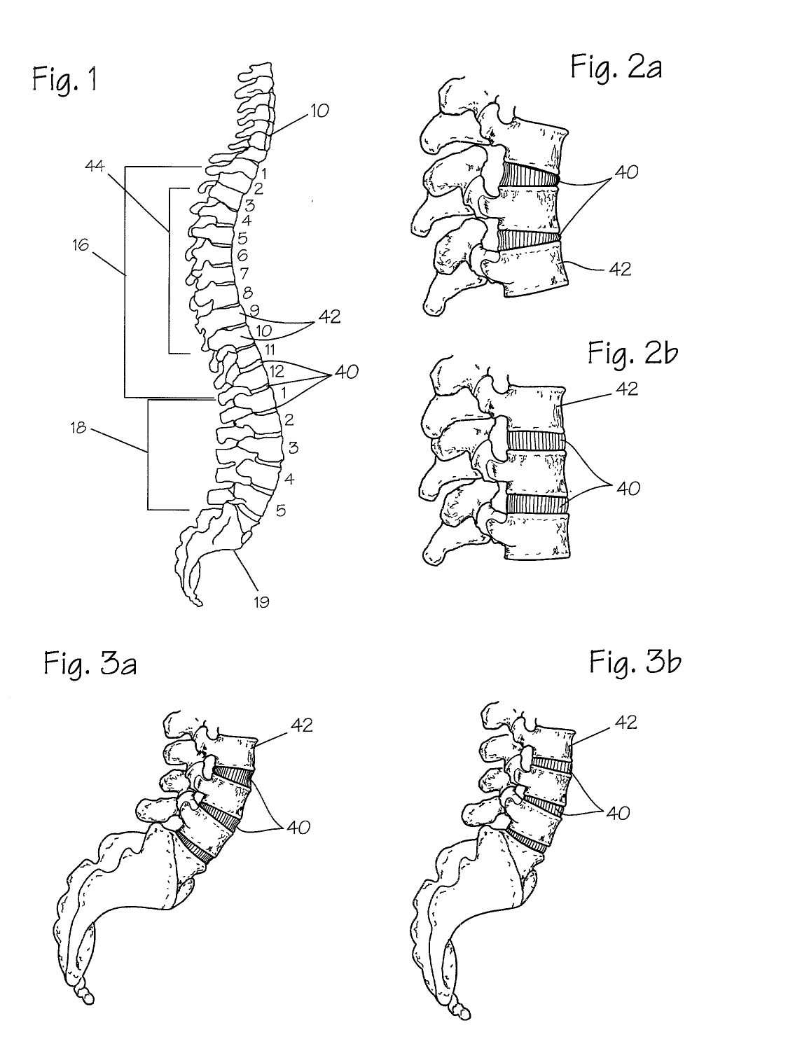

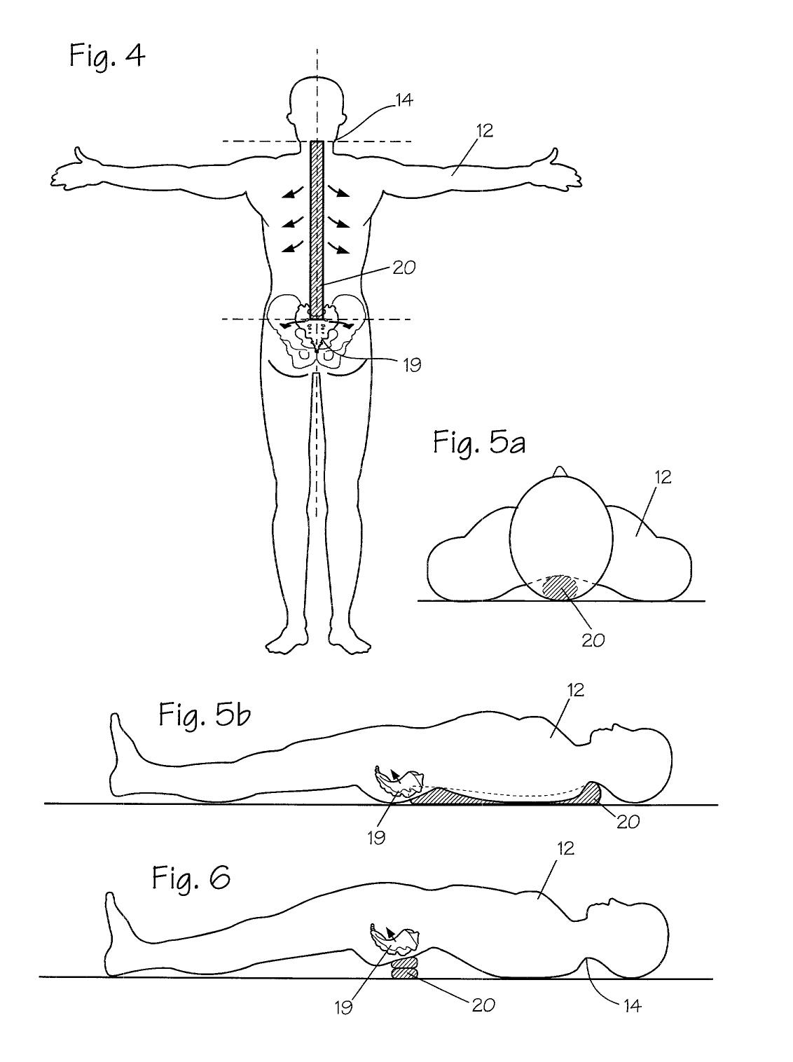

FIG. 1 illustrates a human spine 10, and FIG. 4 illustrates the elongate pad 20 of the invention positioned relative to the spine of a hypothetical person 12. As shown, the pad 20 is about the length of the person's spine, which enables the present pad 20 to be used for alignment and relaxation of the spinal muscles and vertebrae. When lying supine as shown in FIG. 6, the entire spine may be supported without interfering with the natural contour of the spine, whereby the head rests naturally on a primary surface, such as a floor or seat back. In FIG. 5a and FIG. 5b a terminal end of the pad 20 is shown approximately located at the end of the spine during use of the invention along the spinal region. In particular, the end near the user's head terminates at about the base of the skull, and the end near the buttocks terminates at about the pelvis. In this position with the spine supported by the pad 20, the person may manipulate the spine to relieve pain or assist in stretching or correction of spinal related tissue.

FIG. 5b further illustrates that the pad 20 will compress slightly to conform to the shape of the spine and apply even pressure thereto. Lying stationary with the spine supported by the pad 20, the weight of the body evenly displaces the pliable core 22 within the pad 20 to provide relief of spinal discomfort by the uniform pressure applied to the spine. The even pressure applied allows safe and effective and uniform manipulation or support of the tissue and bone involved, which helps ensure proper relief of compression or tension, manipulation or support. Regardless of the configuration of the pad as a support or therapeutic device, the pad 20 will provide firm yet even pressure to the area being supported.

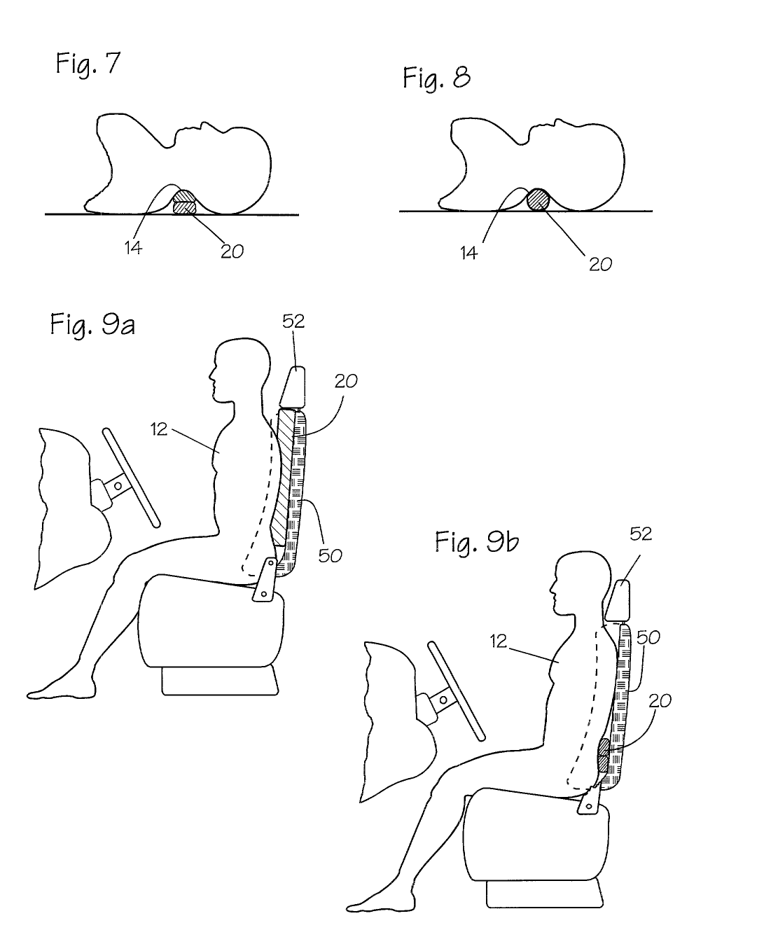

As described, the pad 20 of the invention may be used in more than one capacity. For example, as shown in FIG. 8 the device is demonstrated placed beneath the person's neck to support the neck while a person is reposed. In FIG. 7 the device is also placed beneath the person's neck for support, however, the pad 20 is folded and layered to provide increased thickness. Thereby, the pad 20 can be adjusted to the thickness desirable in supporting the neck while reclined. Yet another alternative would involve folding the pad 20 as shown in FIG. 7, but turning the pad 20 to allow the both cylindrical portions of the pad 20 to rest on the primary surface and provide a wider support for a greater portion of the neck. The exact configuration desirable will depend upon the user's circumstances and needed support.

Several examples of the uses of the pad with respect to the spine 10 in FIG. 1 and the invertebrate discs, and viscoelastic and muscular skeletal tissue thereof may be exemplified by discussion of the various regions of the spine. The illustration of the spine 10 in FIG. 1 includes the thoracic region 16, the lumbar region 18, and the sacro pelvic region 19. As shown in FIG. 2a, the thoracic region 16 includes a number of invertebrate discs 40 that may be compressed and cause discomfort. By aligning the pad 20 as shown in FIG. 5b and lying supine, the vertebrae 42 of the spine 10 may be supported by the evenly applied pressure to relieve the compression of the invertebrate discs 40 as illustrated by FIG. 2b.

FIGS. 3a and 3b show the sacro pelvic 19 and lower lumber 18 regions of the spine 10. The invertebrate discs 40 in the lower lumber 18 region may be placed under stress and tension by the body and cause discomfort. By aligning the pad 20 as shown in FIG. 6 and lying supine, the sacro pelvic region 19 may be supported, which will often assist in relieving the tension in the invertebrate discs 40 in the lower lumber region 18.

FIGS. 9a and 9b illustrate additional examples of the use of the pad 20. Many automobile seats provide inadequate spine or lumber support as represented by the person sitting in the seat 50 shown in FIGS. 9a and 9b. However, with the present pad 20 placed between the seat 50 and the spine as shown in FIG. 9a, the spine may be supported to relieve discomfort or compression of invertebrate discs. Alternatively, the pad 20 could be folded and shaped using the retaining strap 34 and placed behind the lumbar region of the person's back as in FIG. 9b, whereby the lumbar area of the back would be well supported. Also, the pad 20 provides a convenient device for stretching the spine and muscular skeletal tissue to alleviate compression or tension throughout the spinal region.

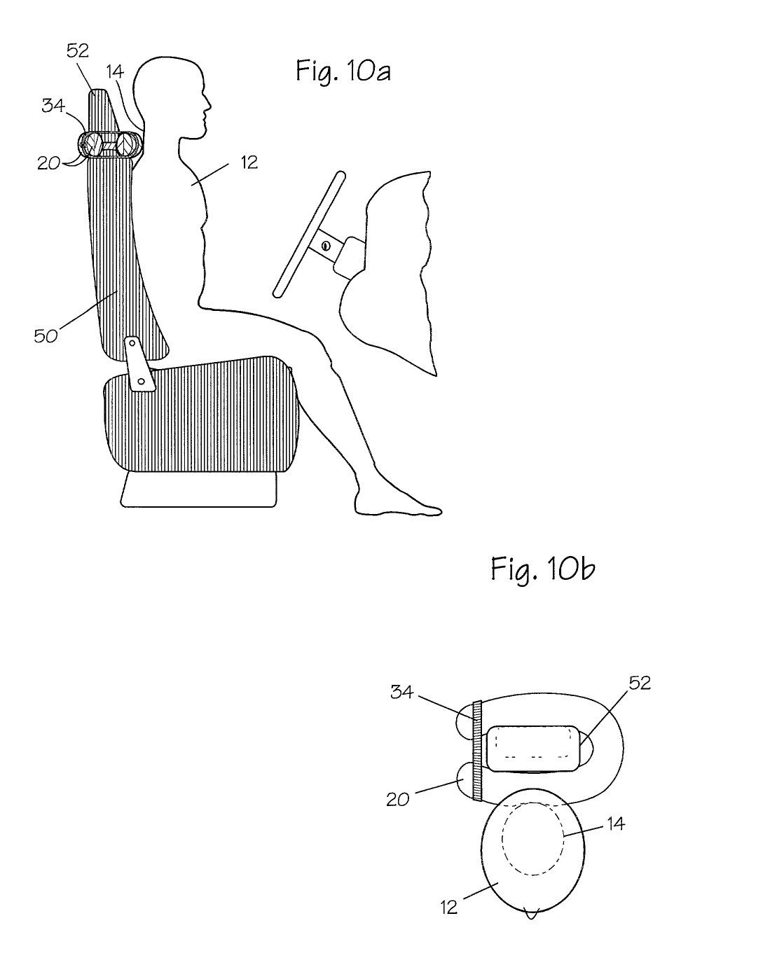

Some automobile seats may lack adequate support of the cervical region of the spine, or it may be desirable to stretch the muscular skeletal tissue in the neck during driving. As shown in FIGS. 10 and 10b, the pad 20 may be wrapped about the head rest 52 of a seat 50 to provide additional neck support. The pad 20 may be retained on the head rest 52 using the retaining strap 34. Thereby, the pad 20 may provide support for the neck and a means for stretching and relieving tension and compression of viscoelastic tissue in the cervical region of the spine. The unique construction of the pad 20 provides a device that is comfortable for resting the neck and applying evenly distributed pressure, while sufficiently firm for support and manipulation of the cervical region of the spine.

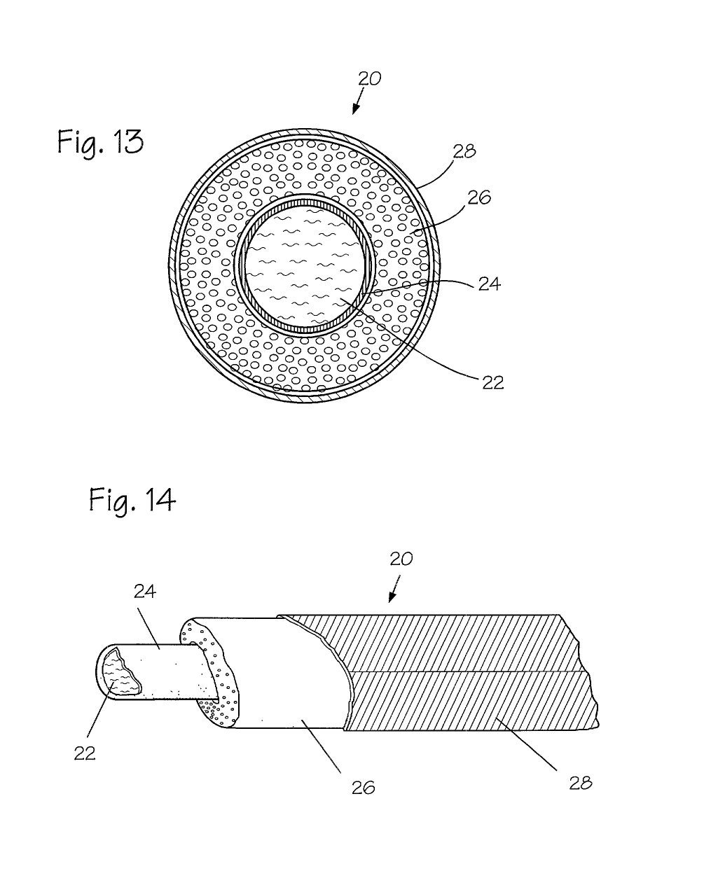

The construction of an embodiment of the pad 20 is shown in detail in FIGS. 11a-14. The four primary components of the elongate pad 20 are shown in cross-section in FIG. 13 and FIG. 14. As described, the pad 20 must be pliable to allow manipulation and even pressure distribution, yet firm to allow use as a support or therapeutic device for manipulating viscoelastic tissue or vertebrae. Thus, the elongate pad includes an elongate core 22 in the central portion of the pad 20 that is comprised of a very pliable and elastic gel or gel-like substance with the desired characteristics of pliability and elasticity.

The core 22 is contained within a thin wall member 24 that is strong flexible and elastic. The wall member 24 envelops the core 22 to form an elongate cylindrical bladder. The wall member 24 should be tear-resistant to prevent the leaking of the core material 22 from the device. The wall member 24 may be heat-sealed to form tubular envelope or may be filled by the gel and sealed by adhesive or suitable means.

The construction of the core 22 using a pliable gel provides greater flexibility and allows uniform compression of the pad 20. Thus, the highly pliable and elastic core 22 promotes the application of uniform pressure by the pad 20 to the body which helps provide the desirable characteristics of comfort and conformity.

The preferred gel material used in the core 22 is a typical gel polymer that is inexpensive to produce and available in bulk for use in manufacture. A suitable gel formulation may be prepared by providing a mixture of 3% polyvinyl alcohol (PVA) dissolved in water. The PVA solution is combined and mixed with 2% sodium borate Na2B4O7●1 01120, also known as Borax, dissolved in water. The PVA and sodium borate solutions may be combined by providing 100 ml of the 3% PVA solution and mixing with 3 ml of the 2% sodium borate solution and stirring vigorously. In addition, the gel polymer may be improved through known processes. For example, a gel polymer may be improved by substituting another base substance for the water to prevent the gel from becoming hard and unusable due to water evaporation. Also, the gel polymer may be improved through known processes to provide a suitable amount of viscous creep when placed under a load to assist in providing even pressure distribution and conformity to the body. Regardless, gel-like substances will generally exhibit the physical properties that promote the even distribution of weight and application of even pressure by being very soft and pliable when contained with the wall member 24. Also, a core 22 containing a pliable gel with a thin flexible wall member 24 will not inhibit the flexibility of the elongate pad 20.

While a core 22 that is comprised of a very pliable and elastic gel or like material provides for flexibility and even pressure distribution, the core 22 by itself would be disadvantageous for many applications considered hereby. The core 22 is too soft and pliable to provide suitably firm support for many applications and does not provide a firm surface for manipulation and stretching of tissue or vertebrae. However, the present invention overcomes these by providing a less pliable elongate tubular member 26 of about the exterior circumference of the core 22.

The tubular member 26 provides a shroud, which encompasses the core 22 and is preferably constructed of polymeric foam. The tubular shroud member 26 may also be formed of a sponge rubber material or the like of sufficient firmness and flexibility. The tubular member 26 may be secured to the exterior of the wall member 24 by adhering, bonding, or attaching as desired. The tubular shroud member 26 is significantly less pliable than the core 22 and enhances the pad 20 by acting as a stiffening element for the elongate pad 20 and decreases the compression and deformation of the pad 20 caused by the weight of a person. The tubular member 26 being less pliable than the core 22 is important because the tubular member 26 provides a sufficiently firm surface for manipulation of tissue and vertebrae and provides firm support. The tubular member 26 is thick enough and firm enough to provide effective support, even for a larger and heavier set person, while still being formed of a flexible material that does not cause the pad 20 to become rigid or hardened and is sufficiently flexible that the elongate pad may still be bent and shaped by folding. Therefore, the tubular member 26 compresses to partially conform itself to the contour of the engaged surface on the supported body.

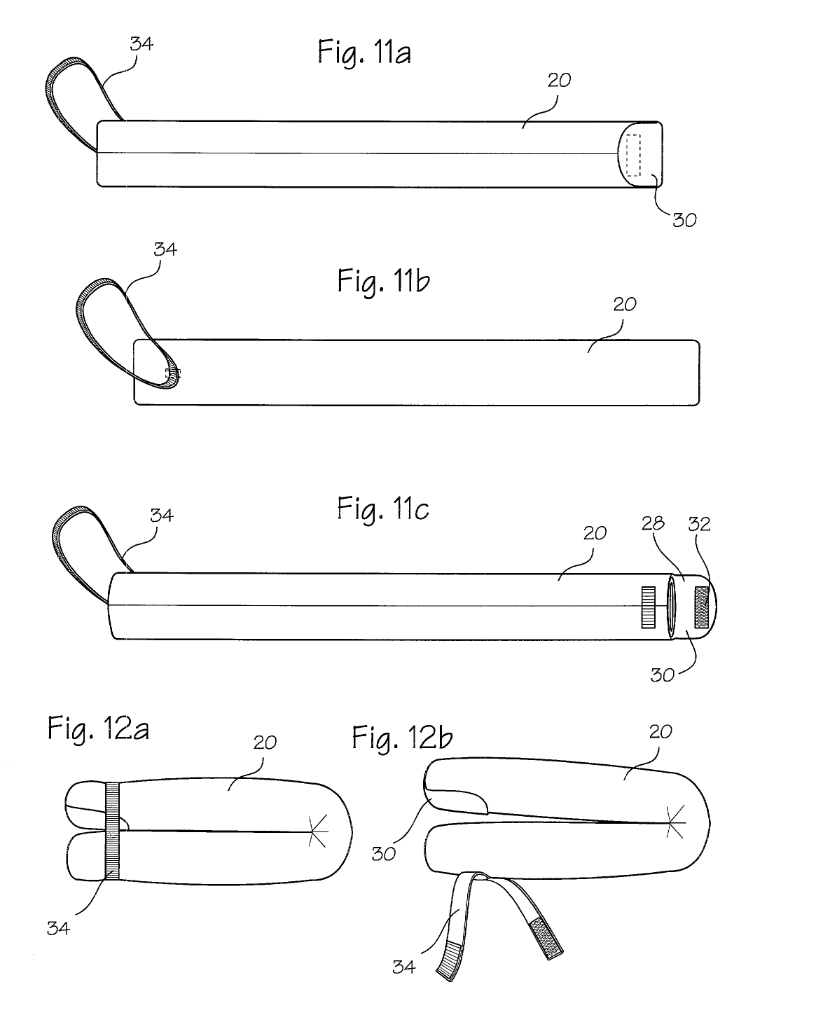

In combination with the tubular member 26, the core 22 will comprise about one-half the diameter of the cross-section of the pad as shown in FIG. 12, and the tubular shroud member will comprise most of the remainder of the diameter of the device, except for a cover 28.

The cover 28 is provided to enhance the elongate pad 20. The cover is formed of a comfortable material such as fabric and is constructed to fit and enclose the elongate core 22 and tubular member 26. The cover 28 includes an opening covered by a flap 30 that is useful for removing the combined core 22 and tubular member 26 for washing the cover. The flap 30 is closed by using an attached closure member 32 such as velcro, a snap, a button, or other device. Velcro hook and loop material works well as a closure member 32 because it is flat, simple to assemble, and is comfortable beneath a person's body bearing on the closure member 32.

One or more elastic retaining strap 34 is included as shown in FIGS. 11a-12b. The retaining strap 34 holds the pad 20 in a particular configuration when the pad 20 is folded to form a shorter and wider or thicker pad 20. The retaining strap 34 is especially valuable when using the pad 20 for lumber or cervical support. The elastic construction of the strap 34 permits the strap to be conveniently stretched over the ends of the pad 20. One strap 34 may do well in retaining the pad 20 in a folded position. However, a second strap or more may be added for additional reinforcement in retaining the shape of the folded pad 20 or to allow additional folds and greater manipulation of the elongate pad 20 into various shapes. Optionally, a closure means such as velcro 36 may be provided on the strap as depicted in FIG. 12b to add additional functionality. Regardless, one should find that the invention provides a therapeutic support pad 20 that is simple, yet very functional.

The present device may be used to relieve pain, normalize joint action, support the spine and neck, support the lower back, or stretch tissue and muscles to relieve tension and compression. The pad 20 does not contain stiffening members like many in the prior art that inhibit reshaping and manipulating the device to various configurations. Instead, the pad 20 is easy to bend and flex to use for a variety of therapeutic and support purposes, and may be used to firmly support the body and to manipulate tissue or vertebrae. The pad 20 is especially advantageous in aligning and relaxing the spine and surrounding tissues by providing firm and evenly distributed pressure on the spine when placed longitudinally beneath the spine of a supine person.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention as defined by the claims.

I claim:

1. A therapeutic support pad comprising:
a pliable and elastic elongate core;
a flexible wall member enveloping the core to form a bladder;
an elongate tubular member covering the wall member, and the tubular member being less pliable that the core and capable of being folded, and the combination of the tubular member and core being cylindrically shaped.

2. A therapeutic support pad as in claim 1 in which the core is comprised of a gel.

3. A therapeutic support pad as in claim 1 including a cover for comfort or aesthetic appeal.

4. A therapeutic support pad as in claim 3 in which the cover includes at least one elastic strap attached to the cover for retaining the pad in a folded configuration.

5. A therapeutic support pad as in claim 2 in which said gel is formed from the combination of a solution of polyvinyl alcohol combined with a solution of sodium borate.

6. A therapeutic support pad as in claim 1 in which said tubular member is comprised of polymeric foam.

7. A therapeutic support pad as in claim 1 which said pad is 2 to 4 inches in diameter.

8. A therapeutic support pad as in claim 1 which said pad is 2.25 to 2.75 inches in diameter.

9. A therapeutic support pad as in claim 1 which said pad is 24 to 36 inches long.

10. A therapeutic support pad as in claim 1 which said pad is 25 to 28 inches long.

11. A therapeutic support pad comprising:
a pliable and elastic elongate gel core;
a flexible wall member enveloping the core to form a bladder;
an elongate tubular member constructed of polymeric foam covering the wall member, and the tubular member being less pliable that the core and capable of being folded, and the combination of the tubular member and core being cylindrically shaped and at least 2 inches in diameter and at least 24 inches in length.
